(19) United States
(12) Patent Application Publication
(10) Pub. No.: US 2006/0192373 A1
(43) Pub. Date: Aug. 31, 2006

(54) Vehicle air bag constructed from a composite film

(75) Inventor: Scott Manley, Gray Court, SC (US)

Correspondence Address: DORITY & MANNING, P.A., POST OFFICE BOX 1449, GREENVILLE, SC, 29602-1449, US

(73) Assignee: Safety Components Fabric Technologies, Inc.

(21) Appl. No.: 11/349,056

(22) Filed: Feb. 7, 2006

Related U.S. Application Data
(60) Provisional application No. 60/650,681, filed on Feb. 7, 2005.
(60) Provisional application No. 60/738,487, filed on Nov. 21, 2005.

(51) Int. Cl. B29C 70/08; B60R 21/235

(52) U.S. Cl. 280/743.1; 428/36.1; 428/36.3; 428/36.2; 428/35.2

(57) ABSTRACT

Air bags for vehicles are disclosed. The air bags are made from a composite material comprising at least one film layer attached to a plurality of reinforcing elements. For instance, in one embodiment, a plurality of reinforcing elements may be located in between a first film layer and a second film layer. In one embodiment, each film layer may comprise a multilayer film. The composite material is particularly well suited to forming side-curtain air bags.

### RELATED APPLICATIONS

The present application is based on and claims priority to U.S. Provisional Patent Application No. 60/650,681 filed on Feb. 7, 2005 and is based on and claims priority to U.S. Provisional Patent Application No. 60/738,487 filed on Nov. 21, 2005.

### BACKGROUND OF THE DISCLOSURE

Within a passenger compartment of a vehicle, many occupant restraint systems can be utilized, such as seatbelts and air bag systems. For instance, air bag systems can supplement the protection offered by seatbelts. Air bag systems typically comprise at least one folded air bag and an inflation gas. The air bag system is designed to inflate the air bag with the inflation gas when a collision between the vehicle and another object is detected.

Usually, air bags are made of a woven fabric to provide strength to the air bag, so that the air bag can withstand the force of an inflation gas quickly inflating the air bag. In addition, some air bags are coated with a composition that can increase the strength, heat resistance, and/or air permeability characteristics of the air bag.

Many different materials, either coated or uncoated, have been utilized in the manufacture of air bags, for example as described in U.S. Pat. Nos. 5,881,776 and 6,632,753, both of which are incorporated by reference herein.

Currently, a need exists for an improved air bag material that is more economical and capable of meeting the requirements needed for use in air restraint devices. Specific performance characteristics that are important to an air restraint device include, for instance, air permeability, tear strength, breaking strength, stiffness, dimensional stability, low blocking characteristics, and seams having sufficient strength and integrity. Airbags should also be able to withstand the relatively hot inflation gas, and the force of the inflation gas at deployment of the air bag while also being able to be stored for extended periods in a tightly packed, small space. Specifically, a need exists for a new air bag material that possesses the above performance characteristics and that is less expensive to produce than many conventional materials and that allows for better control over the gas permeability characteristics of the material.

### SUMMARY

In general, the present disclosure is directed to the construction of air bags for vehicles. The air bags can be made, for instance, from a composite material containing a plurality of reinforcing elements that are attached to or embedded within a film. The film can be formed around the reinforcing elements or can be preformed and then attached to the reinforcing elements. A preformed film, for instance, can be attached to the reinforcing elements through the use of an adhesive resin or through thermal bonding, ultrasonic bonding, and the like.

In one particular embodiment, for instance, the present disclosure is directed to an air bag for a vehicle comprising a hollow bag member defining an opening configured to receive an inflation gas. The hollow bag member is comprised of a composite material. The composite material comprises a first film and a first plurality of reinforcing elements attached to the film. In accordance with the present disclosure, the film can contain a thermosetting polymer or a thermoplastic polymer having a softening point greater than about 100° C., such as greater than about 150° C., such as greater than about 200° C., such as greater than about 250° C. By using a thermosetting polymer or a thermoplastic polymer having a relatively high softening point, the air bag cannot only withstand temperatures that the bag may be subjected to upon inflation but can also withstand the temperatures that a vehicle interior may be exposed to.

In one embodiment, the composite material may further comprise a second film attached to a second plurality of reinforcing elements. The first plurality of reinforcing elements and the second plurality of reinforcing elements may be located in between the first film and the second film. In one embodiment, the first plurality of reinforcing elements and the second plurality of reinforcing elements may be substantially unidirectional. If desired, the first plurality of reinforcing elements may be positioned skew in relation to the second plurality of reinforcing elements. For example, the first plurality of reinforcing elements may be at an angle of from about 45° to about 90° in relation to the second plurality of reinforcing elements.

As described above, the film contained in the composite material may be formed, in one embodiment, by applying an adhesive resin to the reinforcing elements. Alternatively, the reinforcing elements may be laminated to a film.

The composite material of the present disclosure has been found to be particularly suitable for constructing side-curtain air bags. The side-curtain air bag, for instance, may have a shape configured to be positioned alongside of a vehicle compartment. In accordance with the present disclosure, the side-curtain air bag, when tested according to a leak down test and initially inflated to 40 kPa, may retain at least about 60% of its original pressure after 5 seconds, such as about 75% to about 85% of its original pressure after 5 seconds.

The reinforcing elements contained within the composite material may comprise any suitable structure. For instance, the reinforcing elements may comprise multifilament yarns, monofilament yarns, woven tape, wire, braids, slit film, sliver, and the like.

In general, the hollow bag member should be flexible enough to be folded into a compact shape and stored in a vehicle compartment. In this regard, the films contained in the composite material may have a bending stiffness of less than about 15 lbs. according to a circular bend test.

In one particular embodiment, the first film contained within the composite material may comprise a multilayer film. In fact, in one embodiment, the composite material may include a first film, a second film, and a plurality of reinforcing elements located between the first film and the second film. The first film and the second film may comprise multilayer films.

For example, the first film and the second film may include a first polymeric layer and a second polymeric layer, wherein the second polymeric layer has a greater softening temperature than the first polymeric layer. The first polymeric layer of each film may be positioned adjacent to the reinforcing elements. The second polymeric layer, on the other hand, may form the outside surface of the hollow bag member. The first polymeric layer may comprise, for instance, a polyolefin, such as polyethylene or polypropylene, or a polyester. The second layer, on the other hand, may comprise a polyamide or a polyester.

The air bag as described above may be produced using various different methods and techniques. In one embodiment, the hollow bag member may be formed by folding the composite material onto itself and attaching together the free ends of the composite material to form a seam. The seam may be formed, for instance, through thermal bonding, ultrasonic bonding, or may be formed by using radiofrequency waves.

Other features and aspects of the present disclosure are discussed in greater detail below.

### BRIEF DESCRIPTION OF THE DRAWINGS

A full and enabling disclosure of the present invention, including the best mode thereof to one of ordinary skill in the art, is set forth more particularly in the remainder of this specification, including reference to the accompanying figures in which:

FIG. 1 depicts one embodiment of the composite film of the present invention before the two layers shown are sealed together in the composite film.

FIG. 2 depicts a top view of one embodiment of the composite film of the present invention.

FIG. 3 depicts a side view of one embodiment of the composite film of the present invention.

FIG. 4 depicts one embodiment of the composite film of the present invention.

FIG. 5A depicts one embodiment of the composite film of the present invention.

FIG. 5B depicts another embodiment of a composite film of the present invention.

FIG. 5C depicts still another embodiment of a composite film of the present invention.

FIG. 6 depicts an inflated driver-side air bag of the present invention.

FIG. 7 depicts an inflated passenger-side air bag of the present invention.

FIG. 8A depicts an inflated side-curtain air bag deployed within the passenger compartment of a vehicle.

FIG. 8B depicts an inflated side-curtain air bag of the present invention.

FIG. 9 depicts a unidirectional machine of the present invention.

FIG. 10 depicts a cross-ply machine of the present invention.

FIG. 11 is a perspective view of an alternative embodiment of a process for forming a composite film in accordance with the present disclosure.

FIG. 12 is a perspective view of still another embodiment of a process for forming a composite film in accordance with the present disclosure.

### DETAILED DESCRIPTION

Reference now will be made in detail to various embodiments of the disclosure, one or more examples of which are set forth below. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment, can be used on another embodiment to yield a still further embodiment. Thus, it is intended that the present disclosure covers such modifications and variations as come within the scope of the appended claims and their equivalents.

In general, the present disclosure is directed to a composite film comprising, in one embodiment, at least one film layer attached to a plurality of reinforcing elements that extend in at least one direction. For example, the composite film can comprise a first outer film layer, a second outer film layer, and a plurality of yarns, such as multifilament yarns, positioned in between the two outer film layers. The multifilament yarns, for instance, may be substantially parallel to one another and may be incorporated into the composite film without being woven together. The yarns may be thermally bonded to one or more film layers or may be attached to the film layers using an adhesive.

In other embodiments, the composite film can include two or more sets of reinforcing elements, such as multifilament yarns, that extend in multiple directions. For example, in one embodiment, the composite film can include a first set of reinforcing elements that extend in a first direction and a second set of reinforcing elements that extend in a substantially perpendicular direction. The first and second sets of reinforcing elements may be contained between two outer film layers. In still other embodiments, it should be understood that the composite film may include more than two sets of reinforcing elements. The present inventors have found that composite films constructed in accordance with the present invention are well suited for producing air bags for use in vehicles.

In still another embodiment of the present invention, an air bag material is constructed solely from polymeric yarns. The yarns may extend in a single direction or in multiple directions. When extending in multiple directions, the yarns may be woven together or may otherwise be placed in an overlapping relationship. In this embodiment, heat and pressure are applied to the yarns that cause the polymer in the yarns to flow to form a composite film material.

In yet another embodiment of the present disclosure, a composite film material is constructed by coating yarns, such as multi-filament or monofilament yarns, with an adhesive composition. The adhesive composition, when dried, forms a film incorporating the yarns. In this embodiment, the yarns may extend in a single direction, in two perpendicular directions, or in multiple directions. The adhesive composition may be applied to the yarns using various techniques. For instance, in one embodiment, the yarns may be dipped into the adhesive composition. Alternatively, the adhesive composition may be applied to the yarns using, for instance, a slot-coat extruder or any other suitable device. The composite film material may then be used to form an air bag in accordance with the present disclosure.

Most air bags, no matter the application of use, should be able to be folded into a relatively small space. Vehicle manufactures are continually searching for ways to hide an air bag into a small compartment. For instance, the recent trend in the automobile industry has been to pack air bags into small compartments allowing the air bag compartment not to be noticed by a passenger. Thus, the air bag material should be able to be folded and packed without incurring a defect in the air bag, such as a tear or cracking in the surface of the air bag.

Additionally, the air bag material should be able to withstand many temperature changes over a long period, such as years, while being folded and compressed into a small compartment without adversely affecting the function of the air bag when deployed. For example, in a motor vehicle, the temperature inside the vehicle can change drastically from a hot summer day while the vehicle is in the sun to a cold winter night. The air bag must be able to withstand a temperature change while being folded and packed into a small compartment, possibly for years, and must still be able to function as intended in the event of deployment.

As described above, air bags made according to the present invention can be formed from a composite film material. Of particular advantage, composite films made according to the present invention are capable of withstanding temperature changes over a long period of time and are well suited to being folded and packed into small compartments. In fact, composite films made according to the present invention are generally more lightweight than many conventional materials used to form air bags and thus are more compact.

In one embodiment, the composite film of the present invention can also be constructed so as to have strength in one or more linear directions of the film and can be constructed so as to withstand high temperatures, such as the high temperatures associated with air bag inflating gases.

The composite film can be made into an air bag that is more economical to manufacture. Also, an air bag comprising the composite film of the present disclosure can be virtually air-impermeable if desired, which was not possible with many prior art fabrics.

Within a vehicle, there can be different types of air bags employed to protect different areas of the passenger compartment. In general, the properties of air bags and the material from which they are manufactured can differ according to the specific application of the air bag. Due to various considerations, air bags have been constructed of different materials according to the specific application of the air bag. For instance, driver-side air bags have frequently been constructed from a coated woven material or uncoated woven material of very low permeability. Also, passenger-side air bags have often been constructed of uncoated material.

Most air bags are also typically designed to withstand the force of the inflation gas used to inflate the air bag and the relatively hot temperature of the inflation gas. As such, the inner layer of the air bag should be able to withstand relatively hot temperatures while also being able to withstand the amount of force created from the inflation gas inflating the air bag in a relatively small period.

For example, there can be an air bag that deploys in front of the driver of the vehicle to protect the driver from impact with the steering wheel and/or the dashboard of the vehicle (hereinafter “driver-side air bag”). Also, a vehicle can include an air bag that deploys in front of a passenger of the vehicle to protect against collision of the passenger and the dashboard (hereinafter “passenger-side air bag”).

Typically, a driver-side air bag is housed in the steering wheel of the vehicle and must inflate quickly because of the proximity of the driver to the steering wheel and dashboard. Because of the fast inflation of the driver-side air bag, the gas used to inflate the bag is relatively hot. Thus, the inside surface of the air bag, which contacts the inflation gas, should be able to withstand the temperature of the inflation gas.

Of particular advantage, composite films made according to the present invention may be used in any of the above described air bag applications. Specifically, the composite films may be used to construct a driver's side air bag or a passenger's side air bag. The composite films are also capable of withstanding not only inflation gas forces but also inflation gas temperatures.

Referring to FIG. 6, one exemplary embodiment of a driver-side air bag 100 is shown deployed from a steering wheel 110. The driver-side air bag 100 as shown in FIG. 6 may be constructed from a composite film made according to the present invention.

As shown, driver-side air bag 100 appears to be a circular air bag when viewed from the driver seat and an oval air bag when viewed from the side. However, the shape of the air bag can vary according to the particular application of the air bag. Air bag 100 is made of two panels, front panel 120 and back panel 125, which are held together at seam 130. In back panel 125, vent 115 can be seen allowing air to escape the air bag after deployment. Both front panel 120 and back panel 125 comprise the composite film of the present disclosure joined at seam 130 to create a substantially air impermeable bag.

In an alternative embodiment, the air bag 100, instead of being made from only a front panel and a back panel, may also include side panels. The air bag may be gusseted to include a sidewall positioned in between a front panel and a back panel.

Seam 130 as shown in the embodiment in FIG. 6 can be situated outward on the air bag or can be inverted to be facing the inside of the air bag. Seam 130 can join together front panel 120 and back panel 125 by any known method in the art, such as hot melting, stitching, sewing, gluing with an adhesive, sonic or radio frequency welding, thermal bonding, and the like.

When an air bag is used on the passenger-side of the vehicle, the inflation period can be slower because the passenger of a vehicle is typically not as close to the dashboard as the driver is to the steering wheel. Thus, there is a little more time allowed for the inflation of the air bag. However, the inflating gas can be just as hot because a typical passenger-side air bag has more volume, meaning more gas must be used to fill the bag.

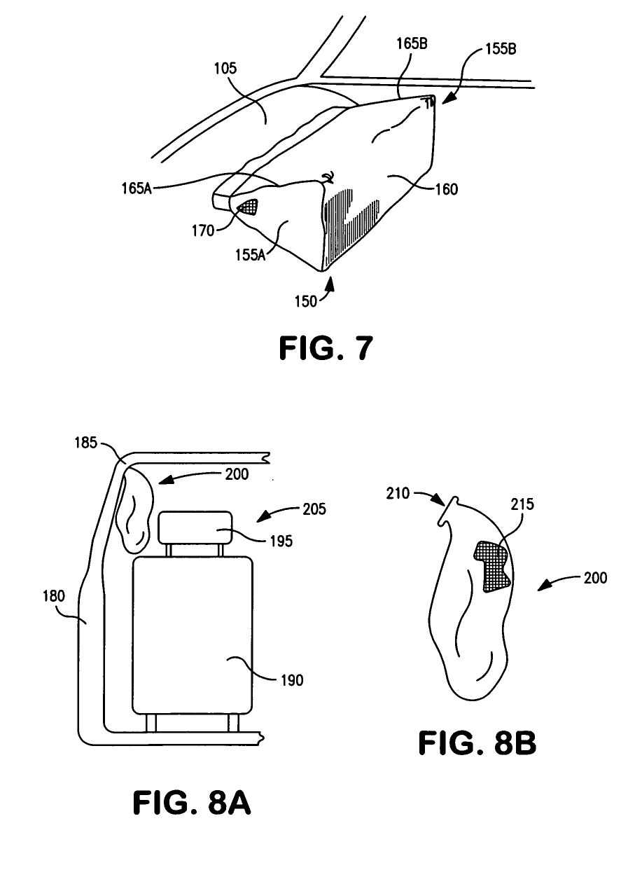

For instance, FIG. 7 depicts passenger side air bag 150 deployed from dashboard 105 within the passenger compartment of a car. As shown, passenger side air bag 150 is made of a front panel 160 and two side panels 155A and 155B, joined at seams 165A and B. As such, front panel 160 and side panels 155A and B can be the composite film of the present disclosure, and can be joined together at seams 165A and B to create an air impermeable bag. Also, vent 170 is shown in side panel 155A to allow the inflation gas to escape shortly after deployment of the air bag.

Typically, both driver-side air bags and passenger-side air bags are designed to quickly deflate after it is inflated by the inflation gas in a process referred to as “leak down.” Thus, vent holes can be utilized in driver-side air bags and passenger-side air bags to help control the deflation of the air bags as it is impacted by the vehicle occupant. As a result, adequate support can be provided to the vehicle occupant without excessive rebounding. Deflation of the air bag also facilitates the ability of a passenger to exit a vehicle once the air bag has deployed. The vents can be located anywhere on the air bag. One skilled in the art may weigh several factors in order to determine the placement, size, and shape of the vents, for instance, the size of the air bag, permeability of the air bag, material, the desired period of inflation, and other factors.

Of particular advantage, the fabric composite materials of the present invention may be constructed so as to be substantially air impermeable. Thus, vents may be used in order to precisely control the leak down rate of air bags made from the composite film. For example, various vents may be formed into the air bag, such as along the seam, so that the air bag deflates in a carefully controlled manner. Conventionally used air bag materials, such as woven fabrics, on the other hand, are typically inherently air permeable which creates problems in designing a bag having a particular leak down rate.

In addition to driver-side and passenger-side air bags, many vehicles are now including other air bag systems to further protect occupants. For instance, many vehicles are now being equipped with side-cushion air bags and/or side-curtain air bags. A side-cushion air bag can typically be mounted in the outboard of a seat within the vehicle. Alternatively, a side-curtain air bag can be mounted along the roof rail of the vehicle and can be designed to deploy downward to protect the passengers from the side-wall of the vehicle and the side-windows of the vehicle.

A side-curtain air bag can also protect passengers from debris of the glass windows of the vehicle's sidewalls that may break or shatter during a collision. In some instances, a side-curtain air bag can extend substantially the length of an interior side of the passenger compartment, protecting passengers in the front seat and the back seat.

FIGS. 8A and 8B depict a side-curtain air bag 200 made in accordance with the present invention that has been deployed. Referring to FIG. 8A, side-curtain air bag 200 is shown deployed within passenger compartment 205 of vehicle 180. Vehicle 180 is shown to have seat 190 with headrest 195 designed to allow seating of an occupant within passenger compartment 205 of vehicle 180. As shown, air bag 200 is deployed in a manner that would protect an occupant of the vehicle from head injury caused by impact of the occupant's head and the side of vehicle 180. Side-curtain air bag 200 is shown deployed from the upper corner rail 185 of vehicle 180. In FIG. 8B, side-curtain air bag 200 is shown without the vehicle 180 present. As such, side-curtain air bag 200 is shown with opening 210 to allow inflation of gas to enter the air bag during deployment. As shown in the figures, air bag 200 is constructed from a composite film made according to the present invention. As illustrated, the composite film contains reinforcing elements 215 that are associated with film layers.

In contrast to driver-side and passenger-side air bags, some side-cushion and side-curtain air bags should remain inflated for relatively long periods, such as several seconds, for continuous protection of the vehicle occupant from additional side impacts or rollover of the vehicle. As such, side-curtain air bag 200 is shown not to include vent holes in the air bag. However, it may be desired to include vents in side cushion or side-curtain air bags in some applications.

Also of particular advantage when designing side-cushion and side-curtain air bags, the composite film materials of the present invention may be substantially air impermeable.

Air permeability is measured by several different tests known in the art, for example, the Frasier test and the Airbag Material Air Flow Test. The Frasier test is generally considered a low pressure (125 Pa) static air test and has results measured in cubic feet per minute. Composite films made according to the present invention may have an air permeability according to the Frasier test of from 0 to about 5 cfm, such as less than about 3 cfm.

The Airbag Material Air Flow Test, on the other hand, is a relatively high pressure (up to 200 kPa) static air test and has results measured in liters per minute. The Airbag Material Air Flow Test is conducted, for instance, using a Airbag Material Air Flow Tester which is commercially available by Cosmo Instruments Co., LTD. Composite fabrics made according to the present invention may have an air permeability according to the Airbag Material Air Flow Test of from 0 to about 20 liters per minute when the machine settings are at 120 kPa and within the Operation Range Mode 2.

It should be understood, however, that composite film materials made according to the present invention can be constructed to have any desirable air permeability and that the above are exemplary ranges.

Another test that is sometimes conducted on air bags is referred to as a “leak down” test. During a leak down test, an air bag is inflated and then the air pressure is monitored over time to record the decrease in air pressure. Thus, the leak down test measures the amount of air pressure within the bag that is reduced after the air bag has been inflated. In one embodiment, for instance, the air bag is initially inflated to a pressure of 40 kPa. The air pressure within the bag is then monitored over a period of time, that is usually a matter of seconds.

In one embodiment, when designing a side curtain air bag, air bags may be made according to the present disclosure that once inflated to 40 kPa retain at least about 60% of the original pressure, such as at least about 80% of the original pressure after five seconds. For example, in one embodiment, after five seconds, the air bag may retain from about 75% to about 85% of its original pressure.

The construction of composite films made according to the present invention will now be discussed in greater detail. As described below, the composite film can be made in various different ways using various different techniques.

In one embodiment, composite films made according to the present invention include at least one film layer laminated to a plurality of reinforcing elements that generally extend in at least one direction. The reinforcing elements may comprise any suitable reinforcing material capable of being laminated to a film layer. For instance, the reinforcing element may comprise a yarn, a woven tape, a wire, braids, slit film, sliver, and the like. In one particular embodiment, for instance, the reinforcing elements may comprise a plurality of multifilament yarns made from a polymeric material.

The film layers used to form the composite films of the present invention may be made from any suitable polymeric material. For example, the film layers can comprise a thermoplastic polymer or a thermosetting polymer. When the film layer comprises a thermosetting polymer, the reinforcing elements may be adhered to the film layer using any suitable adhesive material. When the film layer comprises a thermoplastic polymer, on the other hand, instead of or in addition to using an adhesive material, the reinforcing elements may be thermally bonded to the film layer. For instance, the reinforcing elements may be bonded to the film layer using heat, pressure, air curing, sonic waves, radio frequency waves, and mixtures thereof.

In one particular embodiment, the composite film may comprise a first outer film layer comprising a relatively low temperature polymer, a second outer film layer comprising a relatively high temperature polymer and reinforcing elements contained between the two film layers oriented in at least one direction. In this embodiment, the second film layer made from the relatively high temperature polymer may form the inside surface of an air bag for withstanding high temperatures to which the bag may be subjected when inflated by an inflation gas.

In one embodiment, the composite film can comprise at least one film layer that has been laminated with reinforcing elements to form a composite film. The reinforcing elements may be situated so as to be in a substantially parallel relationship such that substantially none of the reinforcing elements cross and intersect each other. Thus, the reinforcing elements in the composite film are substantially unidirectional (“UD”). In this embodiment, multiple UD composite layers can then be overlaid one on top of another in forming a composite material for use in constructing air bags.

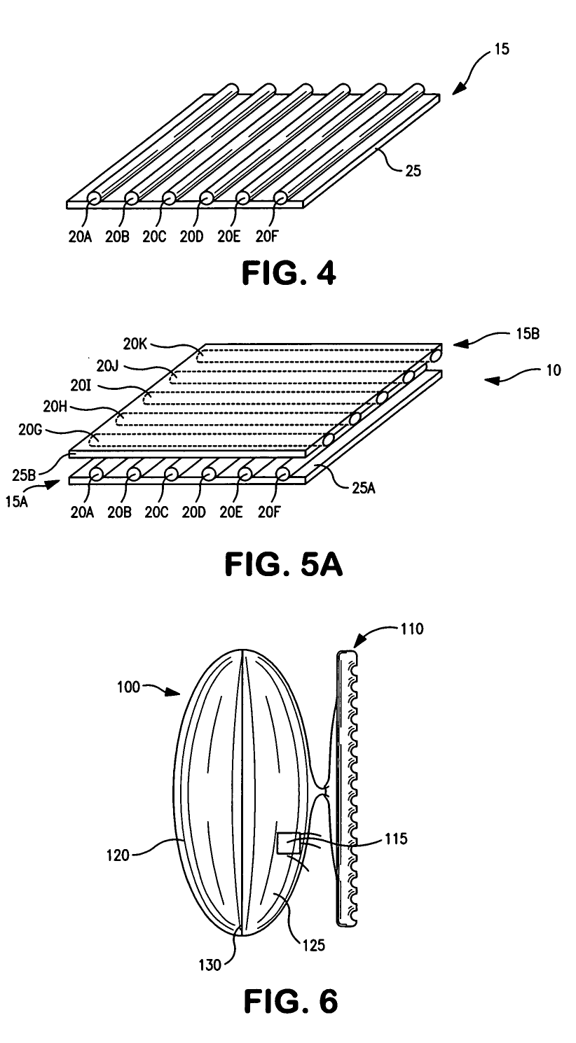

For example, referring to FIG. 4, one embodiment of a UD layer 15 is illustrated containing reinforcing elements that may, for instance, comprise multifilament yarns. As shown, UD layer 15 comprises yarns 20A-F and thermoplastic component 25. FIG. 4 shows that yarns 20A-F are substantially parallel to each other and generally do not intersect at any point across the layer. Also, yarns 20A-F, in this embodiment, are shown to be embedded into thermoplastic component 25. However, in an alternative embodiment, yarns 20A-F could be completely impregnated into thermoplastic component 25 such that no portion of yarns 20A-F is left unsurrounded by thermoplastic component 25. In still another embodiment, the yarns 20A-F may be adhered to the surface of the thermoplastic component 25 using, for instance, an adhesive material. In one embodiment, the thermoplastic component can comprise a high temperature component capable of withstanding the temperatures of the inflation gas during deployment of the air bag. For instance, the high temperature component can withstand relatively brief exposure to temperatures up to about 1000° F. Alternatively, the thermoplastic component can comprise a relatively low temperature component.

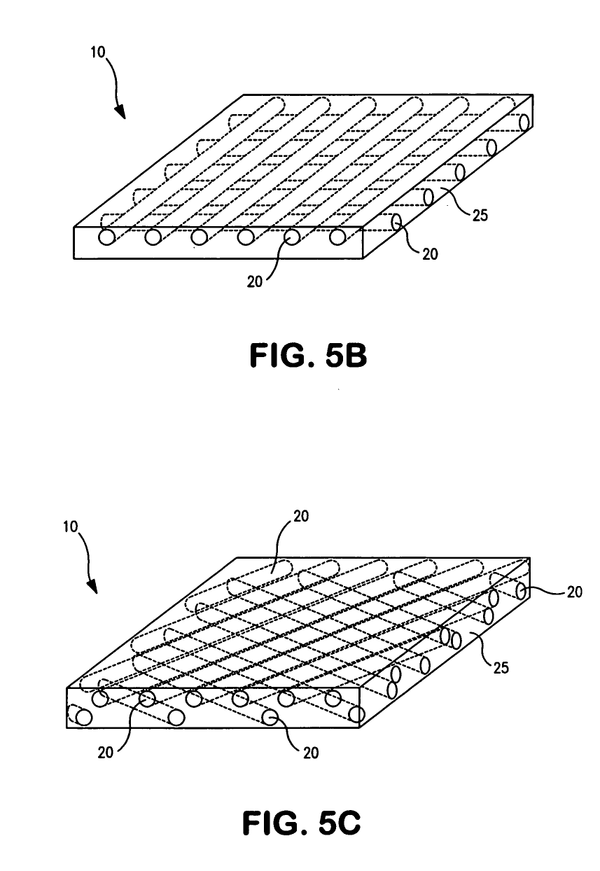

It should be understood, however, that the reinforcing elements need not necessarily be substantially unidirectional. For instance, an alternative embodiment of a composite film containing reinforcing elements is illustrated in FIG. 5B. Like reference numerals have been used to indicate similar elements.

As shown in FIG. 5B, a composite film 10 is illustrated including a film 25 incorporating reinforcing elements 20. In this embodiment, the reinforcing elements are completely impregnated within the film 25. Further, the reinforcing elements extend in perpendicular directions. More specifically, the reinforcing elements extend in a lengthwise direction and in a widthwise direction of the film 25.

Still another embodiment of a composite film 10 is illustrated in FIG. 5C. As shown, the composite film 10 includes a film layer 25 containing reinforcing elements 20. Similar to FIG. 5B, the reinforcing elements 20 are generally contained in the film 25 in two layers. The top layer of reinforcing elements 20 are perpendicular to a bottom layer of reinforcing elements. In this embodiment, however, the reinforcing elements generally extend 45 degrees to the lengthwise direction of the film. In this manner, the reinforcing elements 20 may provide more axial stability to the product.

In the embodiments shown in FIGS. 5B and 5C, the reinforcing elements 20 do not appear to be attached together. It should be understood, however, that in other embodiments, the reinforcing elements may be attached together prior to being incorporated into the film. For instance, the reinforcing elements may be in the form of a scrim or net-like structure prior to being impregnated into the film.

In general, the materials used to form the film layers and/or the yarns to form the composite material may vary depending upon the particular application and various factors. For example, the materials may vary depending upon whether the composite material is used to construct a driver side air bag, a passenger side air bag, or a side impact bag. Any suitable materials may be used that are capable of adequately bonding to form a material with sufficient integrity to withstand deployment. In some embodiments, the material should also be selected so as to form a homogenous film where it is desirable for the air bag to be relatively air impermeable.

In addition, the material chosen should be capable of meeting any required blocking requirements of the material. For example, in one embodiment, the materials used to form the composite film should not flow at or below temperatures to which the material may be exposed when positioned in a vehicle. For example, in one embodiment, materials are chosen that do not flow at a temperature less than about 100° C., such as less than about 250° C. For example, the materials may have a softening point of greater than about 100° C., such as greater than about 150° C., such as greater than about 200° C., such as greater than about 250° C.

The material used to form any film layers and the yarns may also be selected so as to control the stiffness of the resulting composite material. In general, a lower stiffness is generally required. For instance, in one embodiment, the composite material may have a stiffness of less than about 15 lbs. when tested by the “circular bend” method. Stiffness of the composite material can be controlled by selecting materials having proper glass transition temperatures.

In a composite film layer, yarns 20 can comprise, for instance, a nylon, a nylon like fiber, a polyester, glass, a polyamide, a polyolefin, an aramid, a metal, either alone or in any combination. For example, the yarns can be a monofilament yarn. Alternatively, the yarns can be multifilament yarns. For instance, the yarns can have a denier of between about 200 and about 900, such as about 315 to about 840 denier. For instance, in one embodiment, the yarn can be about 420 to about 630 denier. In addition, yarns of different denier or material can be used in a single layer.

The number of yarns or reinforcing elements per inch cross-direction of a layer can vary according to the specific yarn used in the layer. One factor considered when determining the amount of yarns per inch in a layer is maintaining adequate strength in the direction of the yarns. Also, it may be more economical to provide for as few strands per inch as possible while maintaining the adequate strength of the layer. However, having too few yarns per inch could weaken the layer in the cross-direction, allowing the plurality of yarns to be separated from each other. Thus, one skilled in the art can weigh several factors in considering what type and how many yarns can be included in a particular layer in order to meet the performance requirements of the air bag material.

For example, a layer comprising yarn of about 315 denier can have up to about 65 strands per cross-direction inch, such as about 5 to about 60 per inch, for instance about 25 strands per inch. Alternatively, a layer comprising yarn of about 840 denier can have up to 35 strands per inch, such as about 2 to about 32 per inch, for instance about 15 per inch.

Furthermore, the present disclosure encompasses that the yarns in a composite film layer can be the same type of fiber or the yarns can contain different fibers. For instance, a composite layer can comprise one type of yarn throughout the layer. Alternatively, a composite layer can comprise 2 or more types of yarns, such as two or more different sizes of yarn and/or two or more types of fibers. In other embodiments, composite layers may contain other reinforcing elements in addition to or instead of yarns.

In one embodiment, the composite layer can include yarns comprising nylon or a nylon like material. For instance, the yarn can comprise a multifilament yarn that comprises nylon or a nylon like material. In another embodiment, the composite layer can include yarns comprising a polyester. For example, the yarn can comprise a multifilament yarn comprising polyester.

According to the present disclosure, the layer comprising a plurality of reinforcing elements situated so that the elements extend generally in the same direction, such as a composite layer, can also comprise a polymeric film component to hold the plurality of reinforcing elements in their predetermined pattern, such as substantially parallel. The polymeric film component, for instance, may comprise a thermoplastic polymer or a thermosetting polymer.

The polymeric film component not only acts as a carrier for the reinforcing elements but also substantially controls the air permeability of the material.

In one embodiment, the reinforcing elements can be completely impregnated within the polymeric film component. Alternatively, the reinforcing elements may only be partially embedded into the polymeric film component. Also, the polymeric component can bond, either covalently or through charged interactions, to the yarns. In still other embodiments, the polymeric component may be adhesively bonded to the reinforcing elements.

In addition to holding the reinforcing elements in their predetermined pattern, the polymeric component can add other useful characteristics to the composite film. For example, the polymeric component can add air impermeability characteristics to the film. In addition, the polymeric component can also add a temperature resistance component to the composite film. For instance, the inner side of an air bag can comprise a polymeric component that is capable of withstanding the high temperatures of the inflation gas during deployment. Also, an air bag can comprise a low temperature component, such as a low temperature polymeric component on the outside surface of the air bag that is protected from the inflation gas by a high temperature component on the inside of the composite film. Low temperature components can also be used that have low blocking characteristics. Otherwise, a further coating can be applied to the air bag to prevent blocking.

The polymeric film component can be any suitable thermoplastic material or thermosetting material. For example, when the polymeric component comprises a thermoplastic polymer, the thermoplastic polymer can comprise a polyolefin such as a polypropylene or a polyethylene, a polyester, a polyamide, mixtures thereof, copolymers thereof, and the like.

In one embodiment, the polymeric film component may comprise a multilayered film. For instance, the film component may contain layers of a polyamide and a polyethylene. The polyethylene, which has a lower softening temperature than the polyamide, may be for thermally bonding with the reinforcing elements, while the polyamide or nylon layer provides thermal stability and strength.

Thus, in one embodiment, a composite film may be made according to the present invention in which reinforcing elements are contained within the center of the composite film and which extend in at least one direction. The reinforcing elements are sandwiched in between two multilayer films. Each multilayer film includes an outside higher temperature polymer layer, such as a polyamide layer, and an inside lower temperature polymer layer, such as a polyolefin layer, i.e. a polyethylene layer. The polyethylene layer may be thermally bonded to the reinforcing elements. The polyethylene layer may also be used to thermally bond with the opposing film layer.

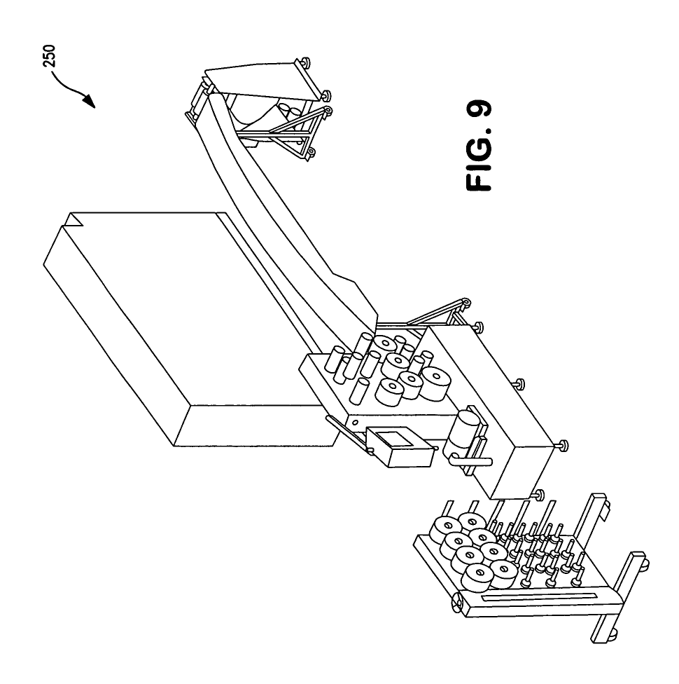

As stated above, a composite film, such as a UD layer can be manufactured using any suitable manufacturing equipment and process as would be known to one skilled in the art. For exemplary purposes only, in one embodiment, a UD layer can be manufactured using a UD machine as depicted in FIG. 9. In UD machine 250, the fibers are supplied to UD machine 250 from packages that are placed on a creel. The yarns or other reinforcing elements are oriented in a predetermined pattern, such as substantially parallel, and then the yarns are impregnated and applied to or embedded into a polymeric component. Optionally, an adhesive can be included in the UD layer in addition to or in place of the polymeric component. After the UD layer is manufactured, the yarns can pass through a set of rollers. The rollers can have different speeds which will eliminate the elongation of the yarns. If needed, the UD layer can then be dried. Finally, the UD layer is wound onto a tube.

As described above, in one embodiment, the UD layer can be formed by bonding yarns to a polymeric film. In an alternative embodiment, however, polymeric yarns, such as filaments, may first be oriented with respect to each other and then subjected to heat and pressure in amounts sufficient to cause the polymer in the yarn to flow. In particular, the yarns are spaced close enough to each other so that a film forms when the polymer flows. The yarns can remain distinct in the resulting product forming a composite film.

In this embodiment, it should be understood that the yarns may also be in multiple directions. For example, the yarns may be oriented in two perpendicular directions or may project in all directions. In fact, in one embodiment, the yarns may be woven together prior to applying heat and pressure and forming the film. In this manner, a composite film material is formed only from the yarns themselves, which may simplify the process in some applications.

In this embodiment, the yarns can be formed from any suitable polymer that is capable of forming a film when subjected to heat and pressure. The yarns may be monofilament or multi-filament.

In one particular embodiment, the yarns used to form the composite material comprise multi-component filaments, such as bicomponent filaments. Bicomponent filaments are yarns that contain a core polymer surrounded by a sheath polymer. When subjected to heat and pressure, the sheath polymer flows forming the film. The core polymer, however, may be a higher temperature polymer and may remain intact during formation of the film. In this manner, the sheath polymer is provided for forming a film while the core polymer provides strength and integrity to the resulting composite. In one embodiment, for instance, the core polymer comprises a polymer that does not flow when subjected to temperatures less than about 250° C., such as about 300° C. The sheath polymer, however, comprises a polymer that flows between 100° C. and about 250° C., such as from about 175° C. to about 250° C. The sheath polymer should be a material capable of forming a film but also capable of withstanding temperatures to which the air bag may be subjected during use. Thus, the sheath polymer should generally have a melting point greater than 100° C., such as greater than about 175° C., such as greater than 200° C.

In one embodiment, the sheath polymer comprises a thermoplastic polymer such as a polyamide, a polyimide, a fluropolymer, a polyester, an acrylic polymer, a polyolefin such as a polyethylene or a polypropylene, mixtures thereof, copolymers thereof, and the like.

In particular examples, the sheath polymer may comprise a polyamide such as polyamide 66, polyamide 6, or polyamide 6.6 including any suitable nylon material. Alternatively, the sheath polymer comprises a fluorocarbon, such as a heat bondable polytetrafluoroethylene.

In still other embodiments, the sheath polymer comprises a polyolefin, particularly a polyethylene or a copolymer of polyethylene as long as the material is capable of withstanding higher temperatures when contained in an air bag and stored in a vehicle or deployed.

Particular polyesters that may used as a sheath polymer include polybutylene terephthlate, polycyclohexylene terephthlate, polycyclohexylene dimethylene terephthlate, polyethylene terephthlate, glycol modified polyethylene terephthlate, combinations thereof, and copolymers thereof.

Still other materials that may be used to construct the sheath polymer include polyarylate, polyphthalamide, polymethylpentene, polyphenylene sulfide, polyaryletherketone, silicones, copolymers thereof and combinations thereof. In still other embodiments, silicone adhesives and urethanes may be used to construct the sheath polymer or may comprise a coating over the sheath polymer.

When constructing a composite material by thermally bonding yarns together, the yarns can generally have the same properties as described above. For instance, the yarns may have sizes ranging from about 210 denier to about 880 denier and may be aligned so as to have a yarn density of from about 35 yarns per inch to about 73 yarns per inch when using a 210 denier yarn or can have a yarn density of from about 30 yarns per inch to about 61 yarns per inch when using a 315 denier yarn. When using a 420 denier yarn, the yarn density can be from about 25 yarns per inch to about 50 yarns per inch. The yarn density can be from about 20 yarns per inch to about 41 yarns per inch when using a 630 denier yarn and can have a yarn density of from about 15 yarns per inch to about 34 yarns per inch when using an 840 denier yarn. It should be understood that the above ranges are only for exemplary purposes and may vary depending upon the particular application. For example, if the yarns are arranged in a random pattern, the yarn densities can vary widely in the machine direction or in the cross machine direction.

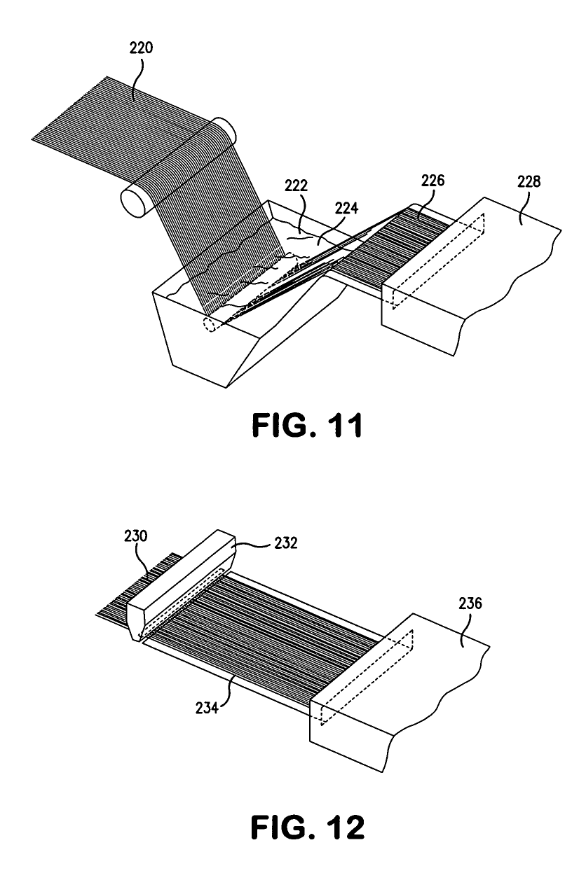

In still another embodiment of the present disclosure, a plurality of yarns are coated with an adhesive composition that, when dried, forms a film incorporating the yarns. The adhesive composition can be applied to the yarns using any suitable process or technique. For example, two different embodiments of processes for applying an adhesive composition to a plurality of yarns are illustrated in FIGS. 11 and 12.

Referring to FIG. 11, for instance, a plurality of yarns 220 are shown that, in this embodiment, are immersed in a bath 222 containing an adhesive composition 224. The adhesive composition 224 coats the yarns as the yarns exit the bath. As the adhesive composition dries, a composite film 226 is formed.

Depending upon the adhesive composition used, the bath 222 may be heated in order to facilitate application of the adhesive composition on the yarns. The bath may be heated, for instance, in order to melt or soften any polymers contained in the adhesive composition, in order to activate the adhesive composition, and/or to control the viscosity of the adhesive composition to ensure that the adhesive composition forms a film in between the yarns.

As shown in FIG. 11, in one embodiment if desired, the process can further include a heating device 228 that receives the composite film 226. The heating device 228 can be used to heat the composite film in order to cause the adhesive composition to dry and/or cure. The heating device 228 may be, for instance, a forced air oven, a microwave heater, an infrared heater, an electrical resistance heater, and the like.

Referring to FIG. 12, another embodiment of a process for applying an adhesive composition to a plurality of yarns is shown. In this embodiment, a plurality of yarns 230 are fed below a slot-coat extruder 232 which applies the adhesive composition onto the yarns. The adhesive composition forms a film containing the yarns 230. The resulting composite film 234 can, if desired, be fed to a heating device 236. Similar to FIG. 11, the heating device 236 may be used to dry and/or cure the adhesive composition.

In the embodiments shown in FIGS. 11 and 12, the yarns 220 and 230 comprise warp yarns extending in a single direction. The yarns are not woven together and are not attached together. The yarns, however, are spaced closely enough to allow for a composite film to be formed once the adhesive composition is applied.

It should be understood, however, that in other embodiments the yarns 220 and 230 may comprise different configurations. For instance, the yarns 220 and 230 may comprise woven fabrics, nonwoven materials, including scrim-like materials. For instance, the yarns 220 and 230 may be formed into a mesh that is later incorporated into the composite film.

The yarns 220 and 230 may comprise any of the yarns discussed above. Proper tear strength and breaking strength can be fulfilled for any particular air bag application by utilizing the proper size of yarn and the proper material. For instance, the yarn may be made from nylon or polyester and may have sizes ranging from about 210 denier to about 880 denier. As merely exemplary, the yarns may have a density of from about 35 to about 75 yarns per inch when using 210 denier nylon or may have a yarn density of from about 30 to about 65 yarns per inch when using 315 denier nylon. In still other embodiments, the yarn density may be from about 25 to about 50 yarns per inch when using 420 denier nylon or may have a density from about 20 yarns per inch to about 45 yarns per inch when using 630 denier nylon. In still another embodiment, the yarn density may be from about 15 to about 35 yarns per inch when using 840 denier nylon. The above ranges are provided merely for exemplary purposes and are not intended to limit the invention described herein.

The adhesive composition used in the process as shown, for instance, in FIGS. 11 and 12 may comprise any suitable adhesive composition capable of forming a composite film with the yarns. The adhesive composition, for instance, should have sufficient flow to achieve adequate bonding between the yarns and the various components. Desirably, the adhesive composition also forms a homogenous film that is resistant to blocking. If desired, the adhesive composition may also be capable of bonding not only to the yarns but to itself in order to form thermal or ultrasonic seams in other areas of the air bag.

The adhesive composition should also be somewhat temperature resistant in that the air bag will be stored in a vehicle that may be subjected to relatively high temperatures. For instance, the adhesive composition should be able to withstand temperatures of from about 100° C. to about 250° C.

The adhesive composition may produce a composite film material that has relatively low stiffness. For instance, in one embodiment, the adhesive composition and yarn combination can produce a composite film that, when subjected to a circular bend test, measures below about 15 lbs. In order to lower the stiffness, one factor to take into consideration is the glass transition temperature of the adhesive composition. Generally lower glass transition temperatures will translate into less stiff materials.

The adhesive composition may comprise a thermoplastic polymer or a thermosetting polymer. The adhesive composition may comprise, for instance, a hotmelt adhesive or any other suitable material. Examples of adhesive compositions that may be used include silicone adhesives, polyolefin adhesives such as polypropylene adhesives and polyethylene adhesives including copolymers thereof, acrylic adhesives, and the like. In still other embodiments, polyurethanes, such as reactive urethanes may be used.

Other processes for producing composite films and various materials that may be used to construct the films are commercially available from Reef Industries, Inc. of Houston, Tex.

Once a composite film layer is formed, multiple layers may be combined together if desired to further improve and control the properties of the resulting material. For example, in one embodiment, one or more UD layers may be combined together. For example, a composite film can be formed that comprises at least two pluralities of reinforcing elements, wherein each plurality is positioned such that the elements in each plurality are directed in a different, non-parallel direction than the other pluralities. In one embodiment, the composite film can be made from overlaying two or more UD layers so that the reinforcing elements in each layer are directed in different directions.

For example, two UD layers can be overlaid such that the directions of the reinforcing elements are substantially perpendicular to each other. In this embodiment, the composite film can have strength in both linear directions.

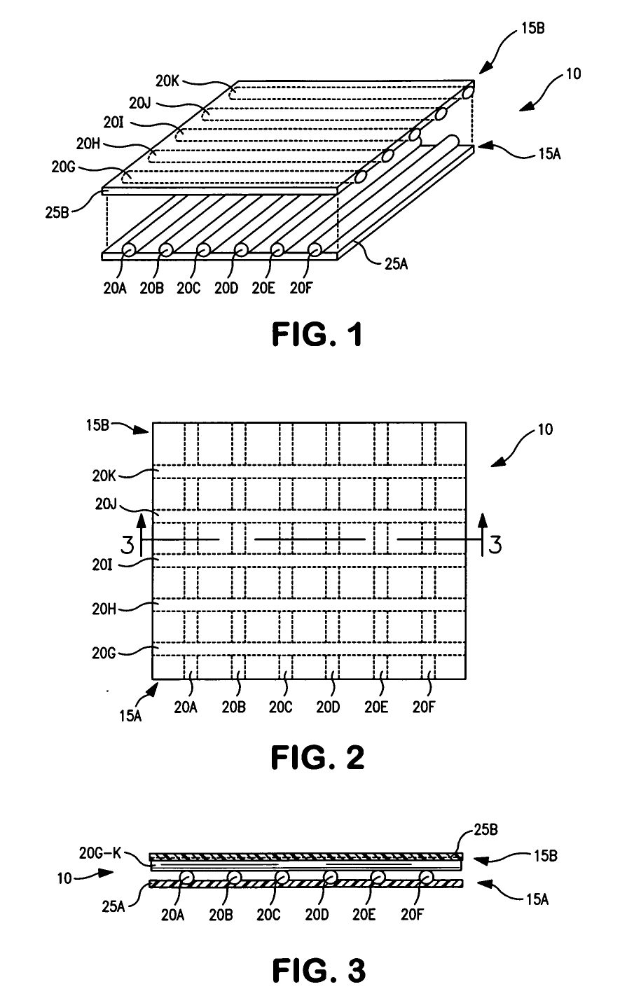

For instance, FIG. 1 depicts composite film 10 comprising two UD layers 15A and 15B. As shown, layers 15A and 15B are being overlaid such that the plurality of reinforcing elements contained in each layer are substantially perpendicular to each other. For instance, in layer 15B, reinforcing elements 20G-K are substantially parallel to each other and are fully impregnated in polymeric component 25A. Alternatively, in layer 15A, reinforcing elements 20A-F are substantially parallel to each other and are partially embedded into polymeric component 25A. As shown, the plurality of reinforcing elements in each layer are substantially perpendicular to each other. For instance, reinforcing elements 20G-20K impregnated into layer 15B are substantially perpendicular to reinforcing elements 20A-F which are embedded into layer 15A. Also, in FIG. 1 there is no middle layer included, such as an adhesive or binding material. However, the absence of such layers shall not be limited on the present disclosure, because the present disclosure envisions the use of a middle layer in some applications, such as a binder, another UD layer, or adhesive.

FIG. 2 is a top view of composite film 10, which shows that when the layers 15A and 15B are overlaid, reinforcing elements 20 are not woven. Specifically, as shown, reinforcing elements 20G-K are overlaid on top of reinforcing elements 20A-F.

Although in FIG. 2, the reinforcing elements are not woven or attached together. It should be understood, that in other embodiments, the reinforcing elements may be bonded together where they intersect. For example, in one embodiment, the composite film 10 may include a scrim material that comprises a woven mesh, a thermally bonded mesh, or the like.

The two or more UD layers can comprise different materials. For example, one UD layer can comprise a high temperature component capable of withstanding the relatively hot inflation gas. Alternatively, another layer of the composite film can comprise a low-temperature component.

The layers can be joined together by any process known to one skilled in the art. For example, the layers can be thermally bonded together without any middle layer or binder. In another embodiment, the layers can be thermally bonded together with a middle layer in between the UD layers. Alternatively, the layers can be glued together by the use of an adhesive or binder. In other embodiments, the layers can be ultrasonically bonded together or bonded together using radio frequency waves.

FIGS. 5A and 3 are views of composite film 10 comprising layers 15A and 15B without the use of an optional middle layer. Layers 15A and 15B can be joined together into composite film 10 by the use of any known means in the art, such as hot melting the two layers together. As shown in FIGS. 3 and 5A, the plurality of reinforcing elements 20A-F in layer 15A is substantially perpendicular to the plurality of reinforcing elements 20G-K of layer 15B. Also, composite film 10 is shown to have polymeric component 25B on one side of composite film 10, while the opposite side of composite film 10 comprises polymeric component 25A.

Optionally, an adhesive can be used to join together the layers. For example, the layers can be glued together through the use of an adhesive such as a polyurethane.

In another embodiment, the layers can only be joined together at the edges of the layers. For example, the layers can be joined together at the seams when the layers are made into an air bag. For instance, the layers can be sewn together at the seams. Alternatively, the layers can be glued together through the use of an adhesive or hot melted together at the edges of the layers to create a seamless joining of the layers.

The equipment and process used in order to join together two or more UD layers in a crossply manner can vary and is generally not critical to the present invention. For instance, any suitable device capable of manipulating the different layers and joining them together using either thermal bonds or adhesive bonds may be used.

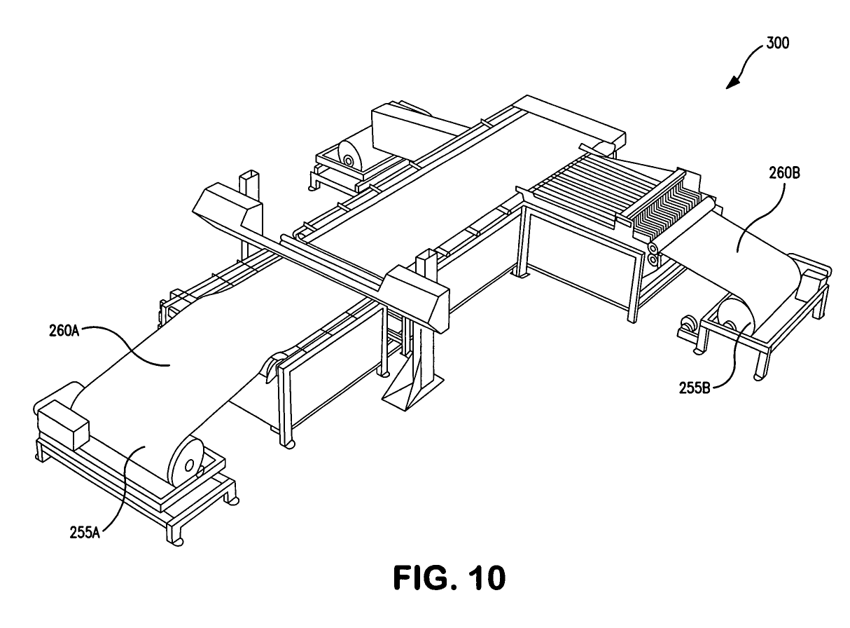

For exemplary purposes only, in one embodiment, the UD layers can be joined together by a crossply machine 300, as shown in FIG. 10. Crossply machine 300 is depicted to join together UD layers 260A and 260B from rolls 255A and 255B, respectively.

As shown, crossply machine 300 takes UD layer 260A and overlays it on top of UD layer 260B as such that the reinforcing elements are all substantially perpendicular between the two layers. Next, crossply machine 300 cuts a length of UD layer 260A to a predetermined size such that the length of layer 260A will match the width of layer 260B in order to form a complete composite film. The cut length is then placed on top of the other UD layer and the cut length and the layer are joined together by any known means in the art.

According to the present disclosure, the composite film can have a mass per unit area of about 2 to about 8 ounces per square yard. Also, the composite film of the present disclosure can have a thickness of about 0.006 to about 0.014 inches.

Once a composite film is constructed in accordance with the present invention, the composite film may be formed into an air bag using any suitable process. Of particular advantage, composite films made according to the present invention are not only generally less expensive than conventional fabrics, but are also generally easier to form into air bags than the conventional fabrics. For example, since the composite film is comprised of polymeric materials, the composite film can be cut and stamped into an air bag in a continuous processing line. The stamping step, for instance, may apply heat and pressure to the composite film in order to thermally bond a first composite film layer to a second composite film layer by forming a seam.

In one particular embodiment, for instance, a composite film may be made according to the present invention. In order to form an air bag, the composite film may be folded to form overlapping layers and then cut into the desired shape of an air bag. The composite film material may then be stamped in order to form a substantially air impermeable seam. Of course, in other embodiments, the stamping step may occur before the cutting step in forming the air bags.

It is to be understood that at least the following language is considered to be enabled by the foregoing description.

In one embodiment, the present invention is directed to an air bag comprising a composite film comprising a first set of reinforcing elements. The first set of reinforcing elements are directed in a first direction. The composite film further comprises a polymeric film component. The composite film has an air permeability of less than about 5.0 cfm, as measured by a Fraiser Tester. In one embodiment, the composite film further comprises a second set of reinforcing elements. The second set of reinforcing elements may be situated in a second direction that is, in one embodiment, substantially perpendicular to the first direction. The first set of reinforcing elements and/or the second set of reinforcing elements may not be woven together or otherwise attached together.

In one embodiment, the air bag includes a first composite film joined to a second composite film at a seam. The composite films used to form the air bag may include at least one set of reinforcing elements. The at least one set of reinforcing elements contained in the first composite film may be oriented in a different direction than the at least one set of reinforcing elements in the second composite film. In general, the composite films may have an air permeability of less than about 5 cfm, such as less than about 3 cfm.

In one particular embodiment, the composite film comprises at least one set of reinforcing elements attached or connected to a film layer. The film layer, for instance, may comprise a film laminate containing at least two films laminated together.

The present invention is also directed to a process for producing an air bag. The process includes the steps of forming at least two composite films wherein each composite film comprises at least a first set of reinforcing elements oriented in at least one direction. The composite films are cut and then joined together at a seam to form the air bag.

In one embodiment, a composite film material is folded over on itself and then cut and joined together in forming an air bag.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. An air bag for a vehicle comprising:
a hollow bag member defining an opening configured to receive an inflation gas; and
wherein the hollow bag member is comprised of a composite material, the composite material comprising a first film and a first plurality of reinforcing elements attached to the film, and wherein the film contains a thermosetting polymer or a thermoplastic polymer having a softening point greater than about 100° C.

2. An air bag as defined in claim 1, wherein the composite material further comprises a second film attached to a second plurality of reinforcing elements, and wherein the first plurality of reinforcing elements and the second plurality of reinforcing elements are located in between the first film and the second film.

3. An air bag as defined in claim 1, wherein the first plurality of reinforcing elements are substantially unidirectional and the second plurality of reinforcing elements are substantially unidirectional and wherein the first plurality of reinforcing elements is skew in relation to the second plurality of reinforcing elements.

4. An air bag as defined in claim 1, wherein the first film contains a thermoplastic polymer having a softening point greater than about 250° C.

5. An air bag as defined in claim 1, wherein the composite material is formed by applying an adhesive resin to the reinforcing elements, the adhesive resin forming the first film.

6. An air bag as defined in claim 1, wherein the composite material is formed by laminating the reinforcing elements to the first film.

7. An air bag as defined in claim 6, wherein the reinforcing elements are attached to the first film by an adhesive resin.

8. An air bag as defined in claim 1, wherein the air bag comprises a side curtain air bag and has a shape configured to be positioned along a side of a vehicle compartment.

9. An air bag as defined in claim 1, wherein the first film comprises a multilayer film.

10. An air bag as defined in claim 2, wherein the first film contained in the composite material comprises a polyolefin polymer and wherein the second film contained in the composite material comprises a polyamide polymer or a polyester polymer.

11. An air bag as defined in claim 1, wherein the reinforcing elements comprise multifilament yarns.

12. An air bag as defined in claim 1, wherein the reinforcing elements comprise monofilament yarn, woven tape, wire, braids, slit film, or sliver.

13. An air bag as defined in claim 1, wherein the first film contained in the composite material has a bending stiffness of less than about 15 pounds according to a circular bend test.

14. An air bag for a vehicle comprising:
a hollow bag member defining an opening configured to receive an inflation gas; and
wherein the hollow bag member is comprised of a composite material, the composite material comprising a first film and a plurality of reinforcing elements attached to the film, and wherein the first film comprises a multi-layered film.

15. An air bag as defined in claim 14, wherein the composite material includes a second film in addition to the first film, the plurality of reinforcing elements being located between the first film and the second film, and wherein both the first film and the second film comprise multi-layered films.

16. An air bag as defined in claim 15, wherein both the first film and the second film comprise a first polymeric layer and a second polymeric layer and wherein the second polymeric layer of each film has a greater softening temperature than the first polymeric layer of each film, and wherein the first polymeric layer of each film is positioned adjacent to the reinforcing elements.

17. An air bag as defined in claim 16, wherein the first polymeric layer of each film comprises a polyolefin or a polyester and wherein the second layer of each film comprises a polyamide or a polyester.

18. An air bag as defined in claim 16, wherein the first polymeric layer of each film comprises a polyethylene or a polypropylene and wherein the second layer of each film comprises a polyamide or a polyester.

19. An air bag as defined in claim 14, wherein the reinforcing elements comprise multifilament yarns, monofilament yarn, woven tape, wire, braids, slit film, or sliver.

20. An air bag as defined in claim 14, wherein the composite material includes multiple layers of reinforcing elements, each layer of the reinforcing elements being unidirectional and wherein one layer is positioned skew in relation to an adjacent layer.

21. An air bag as defined in claim 14, wherein the composite material is formed by applying an adhesive resin to the reinforcing elements, the adhesive resin forming the first film.

22. An air bag as defined in claim 14, wherein the composite material is formed by laminating the reinforcing elements to the first film.

23. An air bag for a vehicle comprising:
a hollow bag member defining an opening configured to receive an inflation gas; and
wherein the hollow bag member is comprised of a composite material, the composite material comprising a first film and a plurality of reinforcing elements attached to the first film, and wherein the reinforcing elements comprise first yarns and second yarns, the first yarns having a different denier or being made from a different material in relation to the second yarns.

24. An air bag as defined in claim 23, wherein the first yarns are contained in a first layer and the second yarns are contained in a second layer.

25. An air bag as defined in claim 23, wherein the first yarns have a different denier than the second yarns.

26. An air bag as defined in claim 25, wherein the denier of the first yarns and the denier of the second yarns is from 315 to 840.

27. An air bag as defined in claim 23, wherein the first yarns and the second yarns are made from a material selected from the group consisting of polyamides, polyolefins, aramids, polyesters, blends thereof, and copolymers thereof.

28. A side curtain air bag for a vehicle comprising:
a hollow bag member defining an opening configured to receive an inflation gas, the hollow bag member having a shape configured to be positioned along a side of a vehicle compartment; and
wherein the hollow bag member is comprised of a composite material, the composite material comprising a first film and a plurality of reinforcing elements attached to the first film, and wherein the hollow bag member when tested according to a leak down test and initially inflated to 40 kPa retains at least about 60% of its original pressure after 5 seconds.

29. An air bag as defined in claim 28, wherein the hollow bag member retains from about 75% to about 85% of its original pressure after 5 seconds according to the leak down test.

30. An air bag as defined in claim 28, wherein the composite material further comprises a second film attached to a second plurality of reinforcing elements, and wherein the first plurality of reinforcing elements and the second plurality of reinforcing elements are located in between the first film and the second film.

31. An air bag as defined in claim 30, wherein the first plurality of reinforcing elements are substantially unidirectional and the second plurality of reinforcing elements are substantially unidirectional and wherein the first plurality of reinforcing elements is skew in relation to the second plurality of reinforcing elements.

32. An air bag as defined in claim 28, wherein the composite material is formed by applying an adhesive resin to the reinforcing elements, the adhesive resin forming the first film.

33. An air bag as defined in claim 28, wherein the composite material is formed by laminating the reinforcing elements to the first film.

34. An air bag as defined in claim 28, wherein the first film contained in the composite material comprises a multi-layered film.

35. An air bag as defined in claim 28, wherein the first film contains a thermosetting polymer or a thermoplastic polymer having a softening point greater than about 250° C.

36. An air bag for a vehicle comprising:
a hollow bag member defining an opening configured to receive an inflation gas; and
wherein the hollow bag member is comprised of a composite material, the composite material comprising a first film and a plurality of reinforcing elements attached to the first film, and wherein the hollow bag member is formed by folding the composite material onto itself and attaching together the free ends of the composite material to form a seam.

37. An air bag as defined in claim 36, wherein the seam is formed by thermally bonding the composite material together where the material overlaps.

38. An air bag as defined in claim 36, wherein the seam is formed by ultrasonically bonding the composite material together where the material overlaps.

39. An air bag as defined in claim 36, wherein the seam is formed by bonding the composite material together using radio frequency waves. of the first film.

40. An air bag as defined in claim 36, wherein the first film contained in the composite material comprises a multi-layered film.

41. An air bag as defined in claim 32, wherein the reinforcing elements comprise multifilament yarns, monofilament yarn, woven tape, wire, braids, slit film, or sliver.
